(19) United States
(12) Patent Application Publication
(10) Pub. No.: US 2006/0214550 A1
(43) Pub. Date: Sep. 28, 2006

(54) Field emission device and method for manufacturing the same

(75) Inventor: Jong Myeon Lee, Seoul (KR)

Correspondence Address: McDermott Will & Emery LLP, 600 13th Street, N.W., Washington, DC, 20005-3096, US

(73) Assignee: SAMSUNG ELECTRO-MECHANICS CO., LTD.

(21) Appl. No.: 11/220,662

(22) Filed: Sep. 8, 2005

(30) Foreign Application Priority Data
Feb. 28, 2005 (KR) 10-2005-16520

(51) Int. Cl. H01J 1/00

(52) U.S. Cl. 313/311

(57) ABSTRACT

A field emission device exhibiting uniform field emission properties and a method for manufacturing the same are provided. The field emission device comprises a metal layer formed on a substrate, a current limiting layer formed on the metal layer, and a plurality of carbon nanotube emitters formed on the current limiting layer. The current limiting layer limits current flowing from the metal layer to the carbon nanotube emitters to a specific value. The current limiting layer can be formed of a ceramic or polymer material exhibiting a positive temperature coefficient (PTC) property.

### RELATED APPLICATION

The present application is based on, and claims priority from, Korean Application Number 2005-0016520, filed Feb. 28, 2005, the disclosure of which is incorporated by reference herein in its entirety.

### BACKGROUND OF THE INVENTION

1. Field of the Invention

The present invention relates to a field emission device and a method for manufacturing the same, and more particularly to a field emission device including carbon nanotube emitters, which have uniform field emission properties and an extended lifespan, and a method for manufacturing the same.

2. Description of the Related Art

Recent field emission devices such as field emission displays and field emission lamps employ carbon nanotubes (CNTs) as field emission emitters. Emitters composed of CNTs (CNT emitters) have a high electrical conductivity and a high field enhancement factor, thus showing excellent field emission properties. If CNTs provided on an electrode substrate are used as field emission emitters, they can emit electrons even at a low voltage, thereby obtaining an excellent field emission device.

A number of methods have been proposed for forming CNT emitters on a substrate. Examples of the methods include a method of growing CNTs on a substrate by chemical vapor deposition (CVD), a method using conductive paste, a method using electroplating, and a method using electrophoresis. It is difficult to widely use the method of using CNT growth to obtain emitters, due to low productivity. Thus, CNT emitters currently used in field emission displays or field emission lamps are typically manufactured using conductive paste, electroplating, or electrophoresis.

However, CNT emitters manufactured by these methods show significant variation in electron emission properties. Such variation has a negative effect upon the emission uniformity and lifespan of field emission lamps or field emission displays. FIG. 1a is a sectional view showing an example of a conventional field emission device, and FIG. 1b is a schematic equivalent circuit diagram of the field emission device of FIG. 1a. As shown in FIG. 1a, a metal layer 12 is provided on a glass substrate 11, and CNT emitters 15 are attached to a conductive layer pattern 14 provided on the metal layer 12. When only two CNT emitters 15 are considered for the sake of convenience, the CNT emitters 15 show specific resistances R1 and R2 as shown in FIG. 1b. However, there are significant differences between the resistances R1 and R2 (R1≠R2) due to differences between the attachment conditions or contact resistances of the CNT emitters 15. Thus, currents I₁ and I₂ flowing through the CNT emitters 15 show significant differences, so that the current distribution is very uneven.

There has been proposed a method of using an additional resistive layer to avoid such non-uniformity of the field emission properties. Specifically, this method involves formation of an additional resistive layer between the substrate and the CNT emitters, so that the variation in the field emission properties of the CNT emitters is reduced, alleviating the non-uniformity of the currents in the CNT emitters. For example, as shown in FIG. 2a, a resistive layer 13 may be formed between the metal layer 12 and the conductive layer pattern 14. FIG. 2b is a schematic equivalent circuit diagram of the field emission device of FIG. 2a. For example, as shown in FIG. 2b, a resistor having a resistance R greater than each of the resistances R1 and R2 of the CNT emitters may be additionally connected to balance currents flowing through the CNT emitters 15 that have significantly different resistances R1 and R2. That is, if an additional resistor R is connected to each of the CNT emitters, the difference between the resistances of the CNT emitter portions is reduced, so that the difference between currents I₁ and I₂ flowing through the CNT emitters is also reduced, thereby ensuring uniform field emission properties of the CNT emitters. The resistance layer 13 shown in FIG. 2a serves as the additional resistor R of FIG. 2b. It can be easily understood from the following equation that the resistance layer 13 has the effect of alleviating the variation in the currents in the CNT emitters.
I₁=(I₁+I₂)×(R2+R)/(R1+R2+2R), I₂=(I₁+I₂)×(R1+R)(R1+R2+2R)

Since R>>R1,R2, I₁≈I₂≈(I₁+I₂)×½

However, if a resistance layer having a great resistance is used as shown in FIG. 2a, the total resistance including the resistance of the CNT emitters is significantly increased. This increases the threshold voltages of the CNT emitters, causing a problem in that it is necessary to apply a higher voltage for field emission. Further, the resistive layer contributes only to reducing the variation in the currents in the CNT emitters, rather than imparting the same field emission property to all CNT emitters. Thus, there are limitations to improving the uniformity of the field emission properties using the resistive layer 13.

### SUMMARY OF THE INVENTION

Therefore, the present invention has been made in view of the above problems, and it is an object of the present invention to provide a field emission device including CNT emitters that show uniform field emission properties at a lower voltage.

It is another object of the present invention to provide a method for manufacturing a field emission device that can reduce the threshold voltages of CNT emitters and significantly improve uniformity of the field emission properties of the CNT emitters.

In accordance with one aspect of the present invention, the above and other objects can be accomplished by the provision of a field emission device comprising a metal layer formed on a substrate; a current limiting layer formed on the metal layer; and a plurality of carbon nanotube (CNT) emitters formed on the current limiting layer, wherein the current limiting layer limits current flowing from the metal layer to the CNT emitters to a specific value. According to the present invention, the field emission device may further comprise a conductive layer between the current limiting layer and the CNT emitters. The conductive layer may be patterned to have a specific pattern.

In one embodiment of the present invention, the current limiting layer may include a positive temperature coefficient (PTC) material. The PTC material may include a ceramic-based PTC material or a polymer-based PTC material. The ceramic-based PTC material includes, for example, n-doped BaTiO₃. The polymer-based PTC material may include a polymer-based PTC material containing a carbon powder and an organic binder. A dopant element, added to the n-doped BaTiO₃, includes La, Y, Gd, Nb, or the like. Pb or Sr may be added to the n-doped BaTiO₃.

The PTC material is characterized by a sharp increase in resistance at a specific temperature. Heat is generated when a large amount of current flows through the PTC material. The temperature of the PTC material increases due to the heat, and the resistance of the PTC material sharply increases at the specific temperature, so that no additional current flows to the PTC material. If a voltage is applied to allow a sufficient current to flow to all the CNT emitters, almost the same current flows to each of the CNT emitters due to such a current limiting property of the PTC material. Since the PTC material, which is a semiconducting material or a conducting material, has a resistance lower than the conventional resistive layer, it is possible to reduce the threshold voltage for field emission.

In accordance with another aspect of the present invention, there is provided a method for manufacturing a field emission device, which comprises forming a metal layer on a substrate; forming a current limiting layer on the metal layer; and forming a plurality of CNT emitters on the current limiting layer, wherein the current limiting layer formed on the metal layer limits current flowing from the metal layer to the CNT emitters to a specific value. In one embodiment of the present invention, the method may further comprise forming a conductive layer on the current limiting layer. The current limiting layer may include a PTC material. The PTC material may include a ceramic-based PTC material, which is preferably formed of n-doped BaTiO₃. Alternatively, the PTC material may include a polymer-based PTC material.

The present invention provides a way to ensure uniformity of the field emission properties of CNT emitters even at a lower voltage than when the conventional resistive layer is used. To accomplish this, the field emission device according to the present invention includes a current limiting layer including a ceramic-based PTC material or a polymer-based PTC material, which is provided between the metal layer and the CNT emitters. The resistance of the PTC material sharply increases at a specific temperature, thereby limiting current in the PTC material.

### BRIEF DESCRIPTION OF THE DRAWINGS

The above and other objects, features and other advantages of the present invention will be more clearly understood from the following detailed description taken in conjunction with the accompanying drawings, in which:

FIG. 1a is a sectional view showing an example of a conventional field emission device;

FIG. 1b is a schematic equivalent circuit diagram of the field emission device of FIG. 1a;

FIG. 2a is a sectional view showing another example of the conventional field emission device;

FIG. 2b is a schematic equivalent circuit diagram of the field emission device of FIG. 2a;

FIG. 3a is a sectional view of a field emission device according to an embodiment of the present invention;

FIG. 3b is a schematic equivalent circuit diagram of the field emission device of FIG. 3a;

FIG. 4 is a graph showing current versus voltage characteristics of a current limiting layer according to the embodiment of the present invention;

FIG. 5 is a graph showing resistance versus temperature characteristics of the current limiting layer according to the embodiment of the present invention;

FIG. 6 is a graph showing temperature versus voltage characteristics of the current limiting layer according to the embodiment of the present invention; and

FIGS. 7 to 10 are sectional views illustrating a method for manufacturing a field emission device according to an embodiment of the present invention.

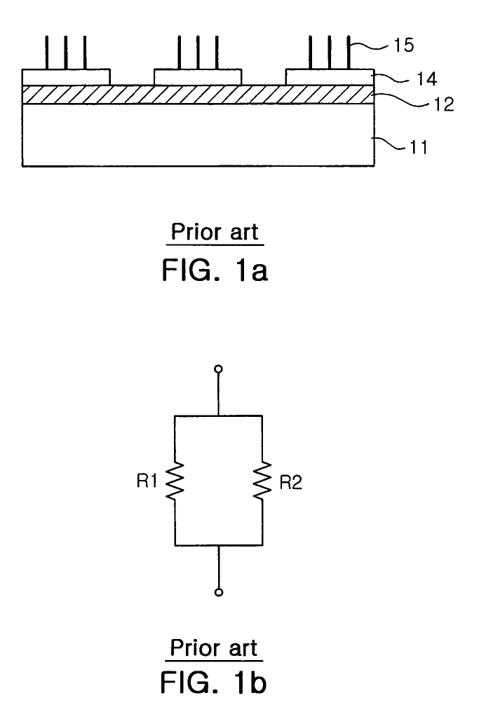

### DESCRIPTION OF THE PREFERRED EMBODIMENTS

Now, preferred embodiments of the present invention will be described with reference to the accompanying drawings. The embodiments of the present invention can be modified into a variety of other forms, and the scope of the present invention is not limited to the embodiments described below. The embodiments of the present invention are intended to provide a more complete explanation of the present invention to a person having average knowledge in the art.

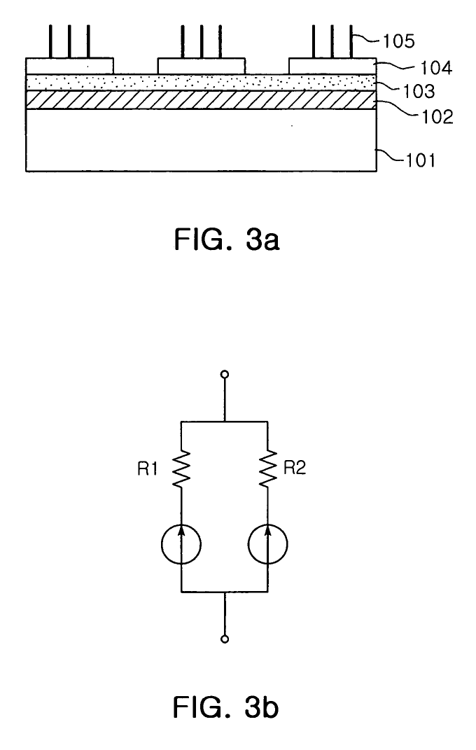

FIG. 3a is a sectional view of a field emission device according to an embodiment of the present invention, and FIG. 3b is a schematic equivalent circuit diagram of the field emission device of FIG. 3a. As shown in FIG. 3b, a metal layer 102, an n-doped BaTiO₃ layer 103, and a conductive pattern 104 are sequentially formed on a glass substrate 101, and CNT emitters 105 protrude from the conductive pattern 104. The n-doped BaTiO₃ layer 103 serves as a current limiting layer to limit a current flowing through the CNT emitters 105 to a specific value. Thus, the field emission device has current sources, which supply constant currents, as shown in the equivalent circuit diagram of FIG. 3b.

The n-doped BaTiO₃ layer 103 is formed by adding a rare-earth element to BaTiO₃. For example, an n-doped (Yttrium-doped) BaTiO₃ material is formed by adding Y₂O₃ to a BaTiO₃ powder and sintering. A rare-earth element, other than Y, which can be doped to form the n-doped BaTiO₃ material, includes La, Gd or Nb. The n-doped BaTiO₃ layer 103 can be formed by depositing the n-doped BaTiO₃ material thus formed on the metal layer 102.

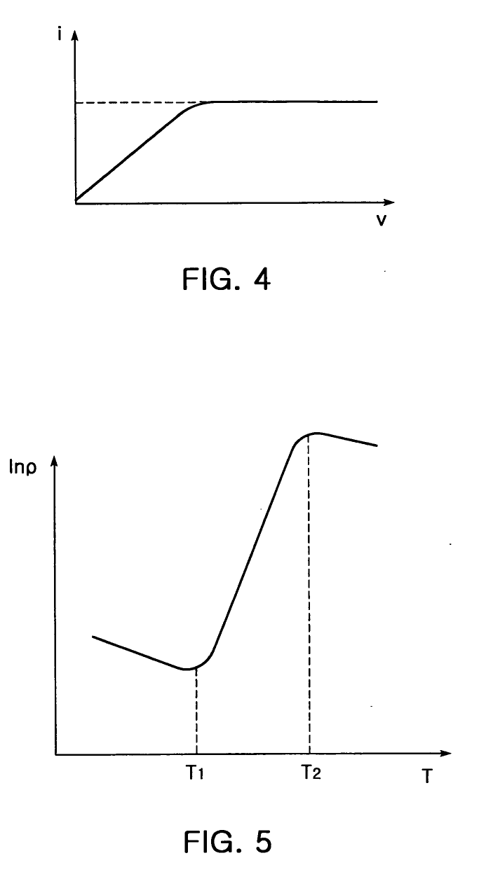

The ceramic-based Positive Temperature Coefficient (PTC) material including n-doped BaTiO₃ is characterized by a sharp increase in resistance at a specific temperature. Heat is generated when a current flows through the field emission device shown in FIG. 3a. If the voltage applied to the field emission device is increased so that a large current flows therethrough, the temperature of the n-doped BaTiO₃ layer 103 is increased and the resistance of the n-doped BaTiO₃ layer 103 is sharply increased at a specific temperature. If the resistance of the n-doped BaTiO₃ layer 103 is sharply increased, the current flowing through the n-doped BaTiO₃ layer 103 is stabilized. That is, the n-doped BaTiO₃ layer 103 serves as a current self-regulator. FIG. 4 is a graph showing the current versus voltage characteristics of the n-doped BaTiO₃ layer 103. As shown in FIG. 4, even if a voltage “V” applied to the field emission device is increased, a current “i” flowing through the n-doped BaTiO₃ layer 103 is constant due to the PTC property of the n-doped BaTiO₃ layer 103.

Pure BaTiO₃ is a dielectric but it can be altered to an n-type semiconductor material by adding a rare-earth element such as Y, La, Gd or Nb thereto. The n-doped BaTiO₃ material, which has been altered to a semiconductor material, has a relatively low resistance at the Curie temperature or less, and its resistance slowly decreases as temperature increases. However, the temperature of the n-doped BaTiO₃ material sharply increases around the Curie temperature, showing a Positive Temperature Coefficient (PTC) property. The Curie temperature may also be referred to as “switching” temperature, which is generally defined as the temperature at which resistance is twice the minimum. Since the resistance of the n-doped BaTiO₃ material sharply increases above the Curie temperature, the n-doped BaTiO₃ material serves to limit the current to a specific value above the Curie temperature.

The current limiting property of the n-doped BaTiO₃ material is associated with phase change at the Curie temperature. The n-doped BaTiO₃ material exhibits a tetragonal structure below the Curie temperature but it is changed to a cubic structure above the Curie temperature. Therefore, the n-doped BaTiO₃ material is characterized by a sharp increase in resistance above the Curie temperature. Ceramic PTC materials including the n-doped BaTiO₃ material exhibit sharply increasing resistance above the specific temperature, showing a current limiting property.

FIG. 5 is a graph showing resistance versus temperature characteristics of the BaTiO₃ layer 103. This graph shows the resistance ρ of the BaTiO₃ layer 103 on a logarithmic scale with respect to temperature. As shown in FIG. 5, in a low temperature range, the resistance ρ of the BaTiO₃ layer 103 decreases as temperature increases. However, if the temperature reaches a specific value T₁, the resistance ρ sharply increases as temperature increases, showing a PTC property. If temperature further increases to reach T₂, the resistance ρ slowly decreases as temperature increases. The Curie temperature of the BaTiO₃ layer 103 is located between T₁ and T₂. Pb or Sr can be added to the n-doped BaTiO₃ material to adjust the Curie temperature. For example, if a fraction of the Ba in the BaTiO₃ crystal lattice is replaced with Pb, the Curie temperature is shifted to a higher temperature, and if a fraction of the Ba in the BaTiO₃ crystal lattice is replaced with Sr, the Curie temperature is shifted to a lower temperature.

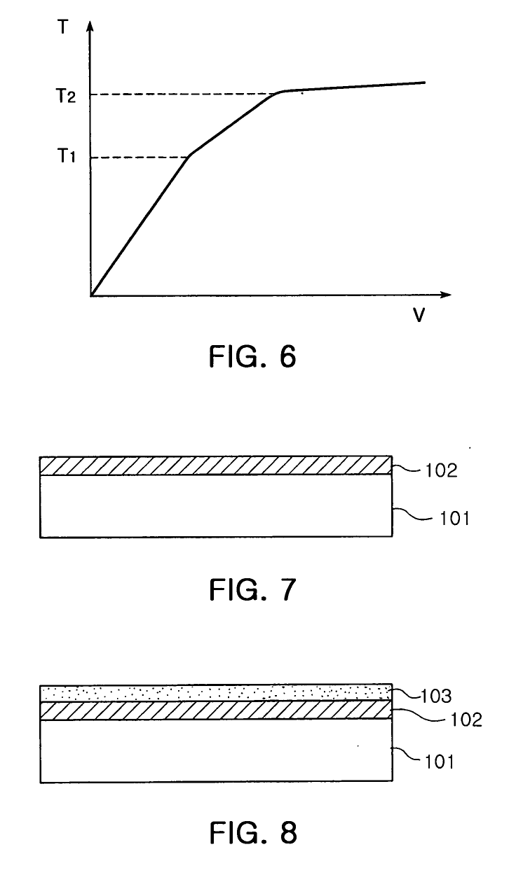

FIG. 6 is a graph showing temperature versus voltage characteristics of the n-doped BaTiO₃ layer 103. As shown in FIG. 6, initially, temperature increases due to heat caused by an increased current in the n-doped BaTiO₃ layer 103. If the temperature reaches T₁, the rate of temperature increase is lowered. Further, if the temperature of the n-doped BaTiO₃ layer 103 reaches T₂, the temperature is fixed to about T₂, without increasing even when the voltage applied to the n-doped BaTiO₃ layer 103 further increases. The current versus voltage characteristics shown in FIG. 4 can be obtained from the graphs of FIGS. 5 and 6.

Such a current limiting property of the n-doped BaTiO₃ layer 103 improves the uniformity of the field emission properties of the CNT emitters. This will now be described in detail.

If a low voltage is applied to the field emission device including the n-doped BaTiO₃ layer 103, CNT emitters having a high field emission property initially emit electrons. If the applied voltage is increased, CNT emitters having a low field emission property also start emitting electrons. However, since the current in the n-doped BaTiO₃ layer 103 is limited to a specific current value, no additional current flows to CNT emitters having a high field emission property even if the applied voltage is further increased. Thus, even if the applied voltage is increased to allow a sufficient current to flow to CNT emitters having a low field emission property, almost the same current flows through every CNT emitter, thereby ensuring uniform field emission properties. The current limiting property of the n-doped BaTiO₃ layer 103 prevents excessive current from flowing through CNT emitters. This increases the lifespan of the CNT emitters, thereby extending the lifespan of the field emission device.

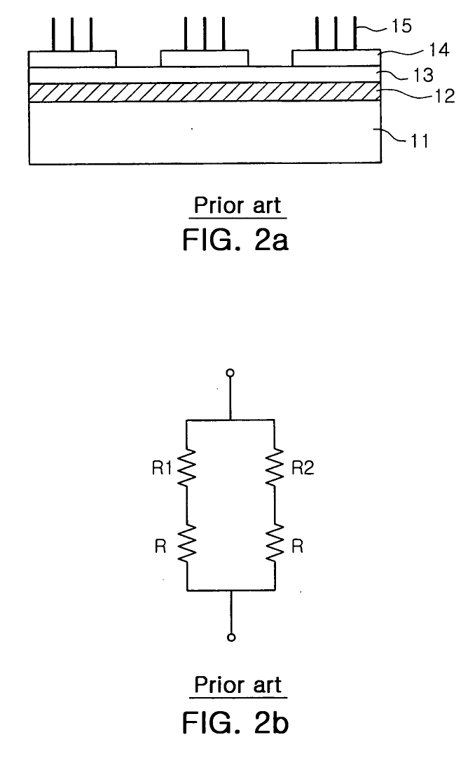

Using the n-doped BaTiO₃ layer 103, which is a semiconducting material, instead of the conventional resistive layer 13 shown in FIG. 2a reduces the total resistance of the field emission device as compared to when the conventional resistive layer 13 is used. This makes it possible to reduce the threshold voltage for field emission. That is, according to the embodiment of the present invention, it is possible to resolve the problem that the threshold voltage increases to a very high level when the conventional resistive layer 13 is used.

Although a BaTiO₃-based material is used for the current limiting layer in the above embodiment, a current limiting layer composed of a different ceramic-based PTC material can also be used. For example, current limiting layers composed of ZnTiNiO-based ceramic materials exhibit similar PTC properties to the n-doped BaTiO₃ layer 103. In addition, a current limiting layer composed of a polymer-based PTC material including a carbon powder and an organic binder may be used instead of the n-doped BaTiO₃ layer 103. The polymer-based PTC material can be produced, for example, by mixing a polyethylene resin or a halogen-based resin with a carbon powder. The polymer-based PTC material exhibits a suitable conductivity and shows a PTC property in which resistance increases as temperature increases.

At equilibrium, since carbon dispersed in the polymer-based PTC material forms a large number of conducting paths, the polymer-based PTC material shows a low resistance. However, if voltage is applied to the polymer-based PTC material, increasing current flowing through the polymer-based PTC material, then temperature increases so that polymers in the PTC material expand with a larger thermal expansion coefficient than that of carbon. As the polymers expand, the conducting paths of carbon are gradually cut, so that the resistance of the polymer-based PTC material is increased, showing a PTC property. This allows the polymer-based PTC material to limit current therethrough.

As with the n-doped BaTiO₃ layer 103, the polymer-based PTC material has a lower resistance than the conventional resistive layer 13. Therefore, using a current limiting layer composed of the polymer-based PTC material makes it possible to ensure uniform field emission properties even at a lower applied voltage, compared to when the conventional resistive layer is used.

FIGS. 7 to 10 are sectional views illustrating a method for manufacturing a field emission device according to an embodiment of the present invention. As shown in FIG. 7, a metal layer 102 is formed on a substrate 101. For example, a glass, quartz, or alumina substrate can be used as the substrate 101. The metal layer 102 formed on the substrate 101 is used as a cathode electrode of the field emission device. The metal layer 102 can be formed of, for example, chrome, tungsten, or aluminum.

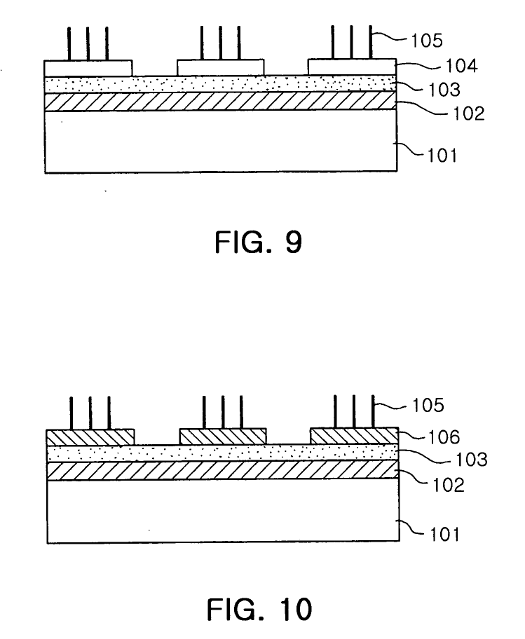

Next, as shown in FIG. 8, an n-doped (yttrium-doped) BaTiO₃ layer 103 is deposited on the metal layer 102. Then, conductive paste containing CNTs is coated on the n-doped BaTiO₃ layer 103, and the coated conductive paste is dried. The conductive paste may be coated on the n-doped BaTiO₃ layer 103 using a screen printing method in order to obtain a CNT emitter array having a desired pattern. Accordingly, the conductive paste forms a conductive layer pattern 104 as shown in FIG. 9, and a number of CNT emitters 105 protrude from the surface of the conductive layer pattern 104. As described above, the current limiting property of the n-doped BaTiO₃ layer 103 allows the CNT emitters 105 to exhibit uniform field emission properties.

Although the CNT emitters 105 are formed using the conductive paste, CNT emitters can also be formed using electroplating or electrophoresis. Further, CNT emitters can also be formed by CNT growth using the CVD method. For example, as shown in FIG. 10, electroplating can be performed to form CNT emitters 105, together with a nickel metal layer pattern 106, on the n-doped BaTiO₃ layer 103.

As is apparent from the above description, the present invention has the following advantages. A current limiting layer is provided under a plurality of CNT emitters, thereby allowing the CNT emitters to exhibit uniform field emission properties. The current limiting layer prevents excessive current from flowing through each of the CNT emitters, thereby increasing the lifetime of the CNT emitters. Thus, the present invention increases the lifetime of a field emission device such as a field emission display or a field emission lamp.

The present invention also uses a ceramic-based semiconducting PTC material or a polymer-based conducting PTC material instead of a conventional resistive layer, thereby achieving a lower threshold voltage for field emission, compared to when the conventional resistive layer is used. This makes it possible to ensure uniform field emission properties even at a relatively low voltage.

The invention is limited, not by the above embodiments and accompanying drawings, but only by the accompanying claims. Those skilled in the art will appreciate that various modifications, additions and substitutions are possible, without departing from the scope and spirit of the invention as disclosed in the accompanying claims.

What is claimed is:

1. A field emission device comprising:
a metal layer formed on a substrate;
a current limiting layer formed on the metal layer; and
a plurality of carbon nanotube emitters formed on the current limiting layer,
wherein the current limiting layer limits current flowing from the metal layer to the carbon nanotube emitters to a specific value.

2. The field emission device according to claim 1, further comprising:
a conductive layer between the current limiting layer and the carbon nanotube emitters.

3. The field emission device according to claim 1, wherein the current limiting layer includes a positive temperature coefficient material.

4. The field emission device according to claim 3, wherein the current limiting layer includes a ceramic-based positive temperature coefficient material.

5. The field emission device according to claim 3, wherein the current limiting layer includes a polymer-based positive temperature coefficient material.

6. The field emission device according to claim 4, wherein the current limiting layer includes n-doped BaTiO₃.

7. The field emission device according to claim 6, wherein a dopant element, added to the n-doped BaTiO₃, is selected from the group consisting of La, Y, Gd and Nb.

8. The field emission device according to claim 6, wherein Pb or Sr is added to the n-doped BaTiO₃.

9. A method for manufacturing a field emission device, the method comprising:
forming a metal layer on a substrate;
forming a current limiting layer on the metal layer; and
forming a plurality of carbon nanotube emitters on the current limiting layer,
wherein the current limiting layer formed on the metal layer limits current flowing from the metal layer to the carbon nanotube emitters to a specific value.

10. The method according to claim 9, further comprising:
forming a conductive layer on the current limiting layer.

11. The method according to claim 9, wherein the current limiting layer is formed of a positive temperature coefficient material.

12. The method according to claim 11, wherein the current limiting layer is formed of a ceramic-based positive temperature coefficient material.

13. The method according to claim 12, wherein the current limiting layer is formed of n-doped BaTiO₃.

14. The method according to claim 11, wherein the current limiting layer is formed of a polymer-based positive temperature coefficient material.
